(19) United States
(12) Patent Application Publication
(10) Pub. No.: US 2009/0265088 A1
(43) Pub. Date: Oct. 22, 2009

(54) SYMBOLOGY FOR A FLIGHT DISPLAY

(75) Inventors: Antonio Dias, Narragansett, RI (US); Steven W. Jacobson, Millbury, MA (US)

Correspondence Address: NIXON PEABODY, LLP, 401 9TH STREET, NW, SUITE 900, WASHINGTON, DC, 20004-2128, US

(73) Assignee: AVIDYNE CORPORATION, Lincoln, MA (US)

(21) Appl. No.: 12/271,328

(22) Filed: Nov. 14, 2008

Related U.S. Application Data
(60) Provisional application No. 60/996,392, filed on Nov. 15, 2007.

(51) Int. Cl. G08G 5/04; G06G 7/76; G08B 21/00

(52) U.S. Cl. 701/120; 701/301; 340/945

(57) ABSTRACT

Flight display systems are provided that present a pilot with a three dimensional view of an area within a potential flight path of an aircraft. The three dimensional view may include representations of potential obstacles and avoidance zones surrounding the potential obstacles. The view may also include cardinal compass representation aligned with the visual horizon. Aircraft traffic obstacle symbols may be variable based on the type of aircraft represented.

### RELATED APPLICATION

This application claims the benefit of U.S. Provisional Patent Application No. 60/996,392 which was filed on Nov. 15, 2007.

### BACKGROUND OF THE INVENTION

1. Field of the Invention

The present invention relates generally flight displays for aircraft. In particular, the present invention relates to symbology for a three-dimensional flight display.

2. Description of Related Art

A conventional primary flight display consists of an analog presentation of flight data distributed over several instruments: an attitude indicator, an altitude indicator, an airspeed indicator, a turn indicator, a heading indicator and a vertical speed indicator, for example. The indicators are primarily mechanical, based on vacuum and pitot-static technology that is less accurate than similar electronic instruments. The pilot must visually acquire, interpret and employ information from at least these six sources across the cockpit.

Currently, the flight displays in many aircraft require pilots to read and interpret navigational cues from a variety of different instruments and in different formats. While synthesizing this information may be a minor mental action in normal circumstances, a pilot inundated with time-sensitive information may face difficulty quickly interpreting valuable data under stressful emergency circumstances. Any extra mental efforts between perception and reaction in emergency situations are best reduced or eliminated.

Another conventional flight display consists of an electronic presentation of the conventional flight instruments on a single display. These displays simply recreate the six primary flight instruments on a single electronic screen, but retaining the symbology of the analog displays. Aircraft having such systems are often referred to as having a “glass cockpit.” These systems offer the advantage of presenting the instruments in a more compacted area, but face the same shortcomings of potential pilot misinterpretation and error as their analog counterparts.

A more recent electronic primary flight display integrates the flight instruments into a two-dimensional terrain image. The terrain includes graphical representations of both manmade and natural structures on the ground and surrounding the aircraft. Obstacles are represented by symbols according to their type and have their height above ground level listed as well as a standard safe avoidance distance to be maintained. The pilot must read the obstacle's height and compare it with the aircraft's altitude on a moving map in order to digest how the obstacle might interfere with the flight path. Compass points are laid along a flat horizon regardless of the terrain altitude, attenuating the relationship between the flight altitude and terrain height. Even seemingly simple assessments like these increase pilot workload and diminish situational awareness.

Other recent electronic primary flight displays integrate the flight instruments into “synthetic vision” representations or projected three-dimensional terrain images. The images are two-dimensional but are displayed in a manner that simulates three dimensions. Such a display is referred to as a “three-dimensional display” herein. For example, U.S. Pat. No. 5,566,073 to Margolin discloses such a display. These displays seek to provide a more accurate view of the ground and surrounding structures, regardless of actual visibility. Although more realistic, these images can be incredibly rich, presenting difficulty for the pilot in processing any overlaid information.

### SUMMARY OF THE INVENTION

One exemplary embodiment includes a flight display having three-dimensional graphical representations of potential obstacles enclosed by an avoidance zone symbol. Advantageously, the pilot only needs to keep the total velocity vector aimed outside of the zone symbol to maintain sufficient separation from the obstacle. The avoidance zone symbol may be translucent, so that it does not block the view of terrain or other obstacles beyond it. The avoidance zone symbol may further be color-coded to enhance visibility within the display and to show the level of potential threat posed by a particular obstacle at the present time. In one example, the avoidance zone symbol may be displayed in cyan when the particular obstacle poses no threat. In another example, the avoidance zone symbol may be displayed in dim yellow when the particular obstacle does not pose an immediate threat. In still another example, the avoidance zone symbol may be displayed in red if the particular obstacle is within a specified time and/or distance from the aircraft's direction of travel. Additionally, the altitude needed to vertically clear the obstacle may display in red. In another example, the total velocity vector may overlay the avoidance zone symbol, gain a high contrast colored border, and/or begin to flash as the threat of the obstacle becomes more imminent. Additionally, an aural alert may accompany the visual warnings. In still another example, the red threats may display over the other attitude director indicator (ADI) instrumentation. At this point, avoiding the obstacle is of the highest priority to the pilot, even over monitoring the ADI instrumentation.

Obstacles may be, for example, ground obstacles or airborne obstacles. Ground obstacles may include mountains, hills, buildings, antennas, smokestacks and/or any other natural or manmade land features. Airborne obstacles may include aircraft and/or any other flying or floating natural or manmade objects above ground level.

The standard aeronautical chart symbols of these obstacles may be embedded in the graphical display, maintaining the direct connection between any two-dimensional map being used as a navigational aid. A pilot may directly make the connection between the flight display and the navigational aid, without extra mental processing.

In another embodiment, obstacle depictions may be scaled according to their relative distance from the aircraft. Advantageously, the scaling of the obstacles may be exaggerated to make them more easily visible than they would otherwise appear in reality. In keeping with two-dimensional displays, aircraft traffic obstacles may further display relative altitude numerically and vertical rate of climb by a arrow oriented to the direction of vertical speed and scaled to the rate of change in altitude.

Still another embodiment includes a flight display having cardinal compass points depicted along the visual horizon at the point where the sky meets the terrain, no matter what the terrain height above level horizon. Advantageously, the compass point may display above high terrain, emphasizing that terrain in that direction is higher than in other directions, and even possibly higher than the flight level of the aircraft.

In another embodiment, aircraft obstacles may be displayed in either a generic aircraft silhouette or an oriented aircraft depiction. Advantageously, the depictions may show an oriented aircraft depiction using the relative positions of its navigational lights as another cue to the aircraft's relative orientation. The aircraft obstacles may further be displayed in specific aircraft symbology that discriminates between aircraft types, such as, for example, Glider, GA Single or Twin, and/or Heavy. These distinctions may have consequences for the kind of avoidance to be attempted by a pilot, or what typical behavior to expect from that aircraft.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 is a block diagram of a preferred embodiment of a flight display system;

FIG. 2 illustrates an exemplary flight display having ground obstacles;

FIG. 3 illustrates an exemplary flight display having both ground and airborne obstacles;

FIG. 4 illustrates an exemplary flight display having imminent traffic threats;

FIG. 5 illustrates an exemplary flight display having the total velocity vector outside of the avoidance zone;

FIG. 6 illustrates an exemplary flight display having the total velocity vector inside of the avoidance zone;

FIG. 7 illustrates an exemplary flight display having the cardinal compass points depicted along the visual horizon; and

FIG. 8 is a schematic illustration of a flight display.

### DETAILED DESCRIPTION

An improved system for integrating flight data into a three-dimensional electronic display is described. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement. In some instances, well-known structures and devices are shown in block diagram form in order to avoid unnecessarily obscuring the preferred embodiment.

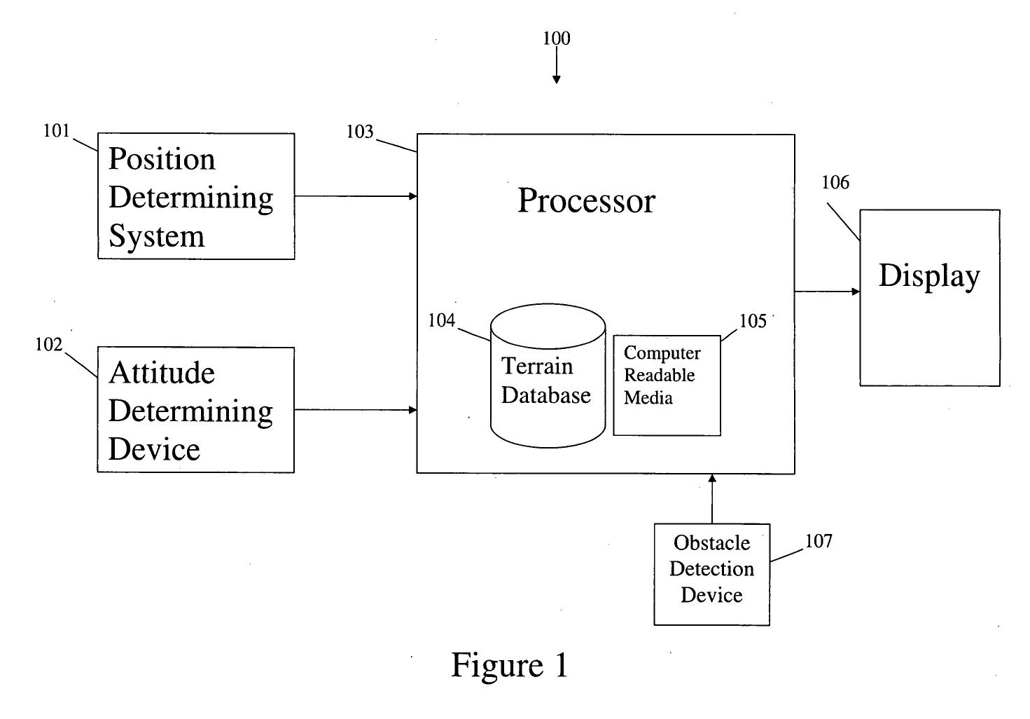

Referring now to the drawings, wherein like reference numerals designate identical or corresponding parts throughout the several views, and more particularly to FIG. 1, which shows primary flight display system 100 comprising position determining system 101, attitude determining device 102 and obstacle detection device 107, which may be operatively coupled to processor 103. Position determining system 101 may be, for example, a global positioning system (GPS) device. Attitude determining device 102 can be any known device for determining attitude of an aircraft. For example, a conventional air data attitude heading reference system (ADAHRS) can be used. Obstacle detection device 107 may be, for example, a radar, or any other device that can detect aircraft and/or obstacles in a known way. Processor 103 may be a computing device executing software instructions in a known manner, and can include terrain database 104 storing terrain data and computer readable media 105 for storing software instructions. The terrain data can be in the form of geographic information systems (GIS) data. The terrain data can include data indicating natural terrain, such as mountains, and manmade obstacles, such as buildings and towers. Ground obstacle information may be stored in terrain database 104, detected from obstacle detection device 107, or both. Processor 103 may be coupled to display device 106. Flight display system 100 can be disposed completely or partially within an aircraft, such as a fixed wing craft or a helicopter.

In the preferred embodiment, primary flight display system 100 is installed in an aircraft. It should be noted that portions of system 100 can be installed in other locations. For example, display device 106 could be disposed in a ground control center or another aircraft in the case of an aircraft being controlled remotely. When the aircraft is in flight, position determining system 101 provides position data, indicating the aircraft position in three dimensions in a known manner to processor 103. Similarly, attitude determining device 102 provides attitude and heading information, indicating the attitude and heading of the aircraft in three dimensions to processor 103. Obstacle detection device 107 provides aircraft traffic and/or obstacle data to processor 103. Processor 103 executes instructions stored on computer readable media 105 in the form of an executable computer program to thereby process the position data and the attitude data in order to ascertain the position, heading and attitude of the aircraft in a known manner. Processor 103 retrieves terrain and/or ground obstacle data from terrain database 104 and aircraft traffic and/or ground obstacle data from obstacle detection device 107 to create display data indicating a three-dimensional view of the terrain surrounding the aircraft. The display data is input to display device 106 to cause a display of the terrain thereon. This process is updated or reiterated periodically or continuously in order to provide the pilot or other persons with a display of the terrain surrounding the aircraft in a way that simulates the actual view of the pilot from the cockpit. Display device 106 may be any synthetic or non-synthetic electronic display, including an enhanced vision display, or any other known display device.

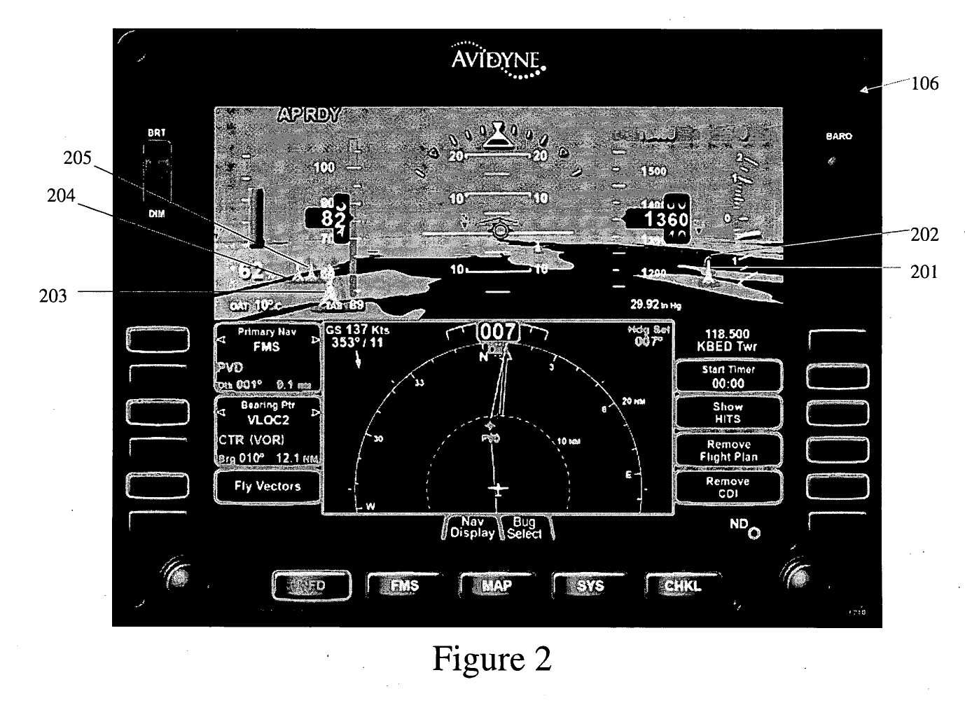

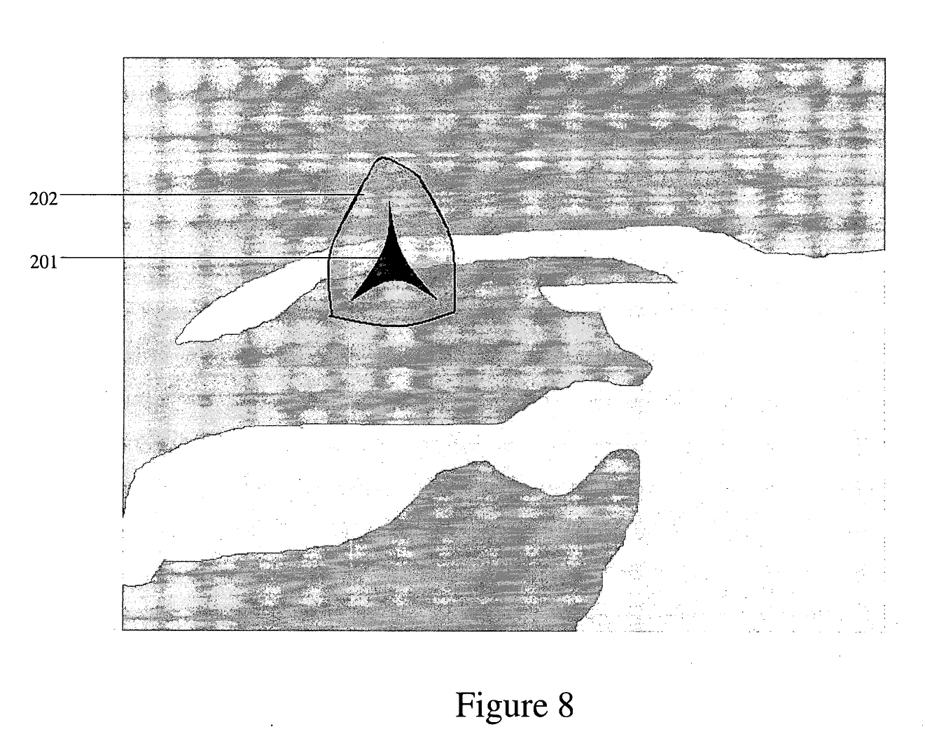

FIG. 2 shows an exemplary display of display device 106 illustrating ground obstacle symbols representing ground obstacles in the flight path of the aircraft. The display is displayed on display device 106. The ground obstacle symbols may appear on the terrain of the display and may be surrounded by an avoidance zone symbol. Avoidance zone symbols may have a geometric shape, such as a circle, oval, square, rectangle, triangle, semi-circle, semi-oval, or any other indicator representing the safe distance an aircraft should maintain from an obstacle. For example, as shown in FIGS. 2 and 8, ground obstacle symbol 201 is surrounded by a semi-oval avoidance zone symbol 202. Avoidance zone symbol 202 may be translucent so that it does not block of the view of the ground obstacle symbol 201 or the terrain. Avoidance zone symbol 202 may be variable in color, such as cyan-, yellow- or red-colored depending on the level of potential threat posed by obstacle 201 at that particular time.

Ground obstacle symbols may be standard aeronautical chart symbols conventionally used in the art of flight displays. Ground obstacle symbols may further be scaled according to their relative distance from the aircraft. For example, ground obstacle symbol 203 appears larger than ground obstacle symbols 201, 204 and 205. Thus, ground obstacle 203 may be closer in relative distance to the aircraft than ground obstacles 201, 204 and 205. Avoidance zone symbols may also be scaled according to the scaling of their respective ground obstacle symbols.

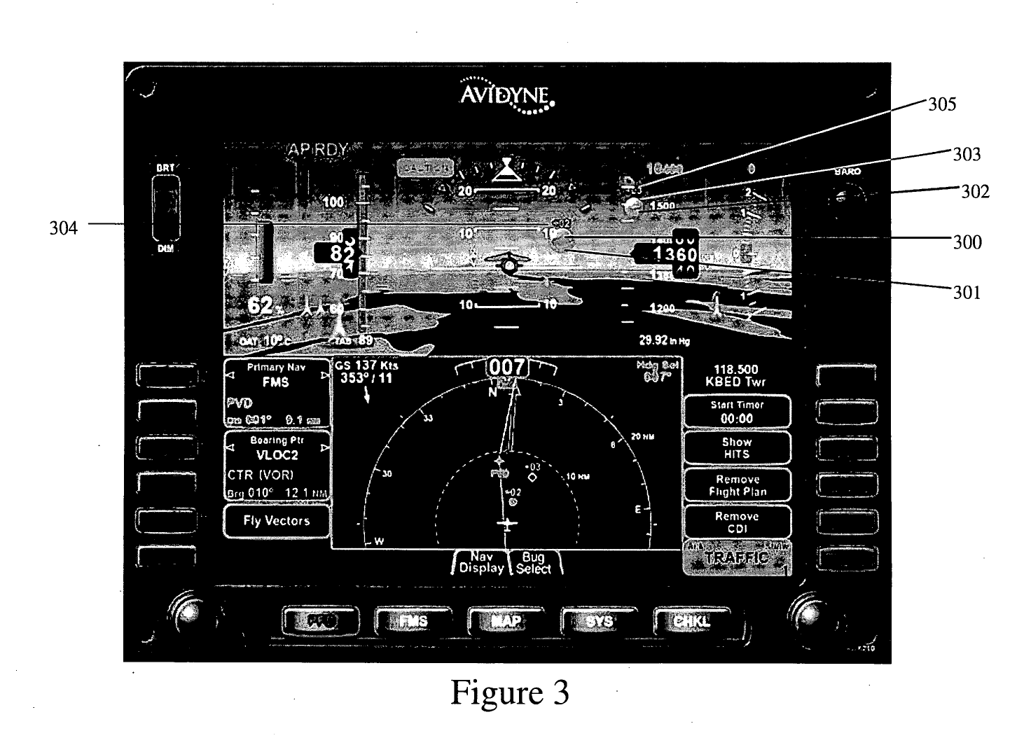

FIG. 3 shows an exemplary flight display illustrating both ground obstacle symbols representing ground obstacles in the flight path of the aircraft and airborne obstacle symbols representing airborne obstacles, such as other aircraft, in the potential flight path of the aircraft on a single display of display device 106. The ground obstacle symbols may be represented as shown in FIG. 2 and described in the accompanying description. The airborne obstacle symbols may appear projected on the terrain or in the airspace and may be surrounded by an avoidance zone symbol. For example, airborne obstacle symbol 300 is surrounded by a circle-shaped avoidance zone symbol 301. Avoidance zone symbol 301 may be translucent so that it does not block the view of the airborne obstacle symbol 300 or the projected terrain or airspace. Avoidance zone symbol 301 may be variable in color, such as cyan-, yellow- or red-colored, depending on the level of potential threat posed by obstacle 300 at that particular time.

Airborne obstacle symbols may change in size according to the airborne obstacle's relative proximity to the aircraft. For example, airborne obstacle symbol 300 appears larger than airborne obstacle symbol 302. Thus, airborne obstacle 300 is represented as being closer in relative distance to the aircraft than airborne obstacle 302. Avoidance zone symbols 301 and 303 may also be scaled according to the scaling of their respective airborne obstacle symbols. Airborne obstacle symbols 300 and 302 may further indicate their respective relative altitudes 304 and 305 per horizontal situation indicator display conventions.

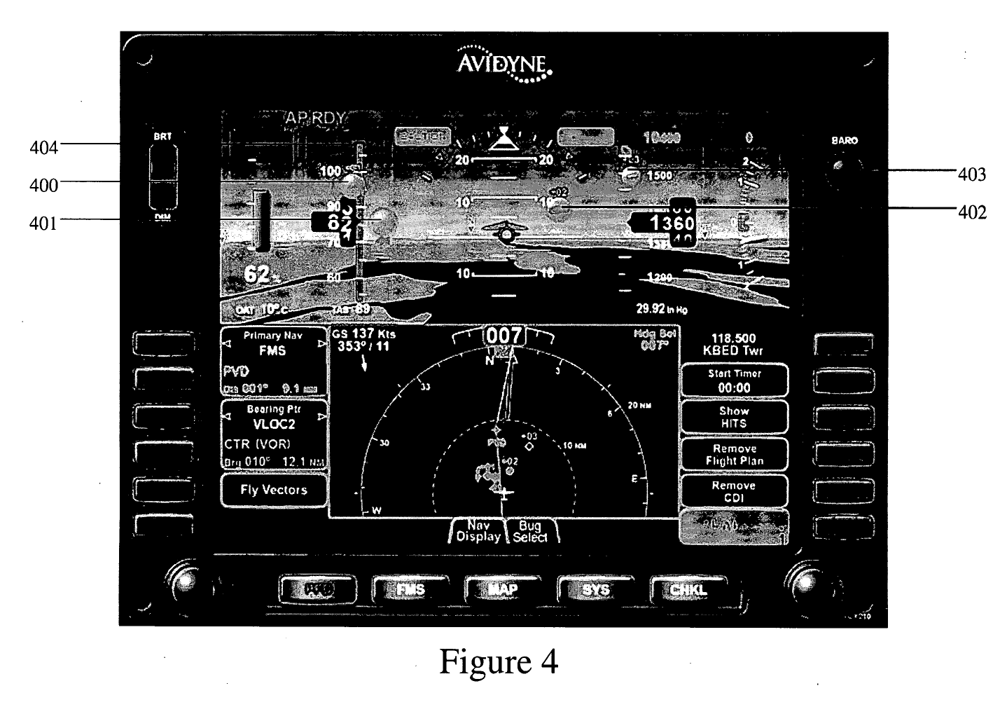

Imminent obstacle threats may include distinguishing features that emphasize the threat involved. FIG. 4 shows an exemplary flight display illustrating imminent airborne obstacle threats. Imminent airborne obstacle threats 400 and 401 appear larger than airborne obstacle symbols 402 and 403 that do not pose imminent threats. Imminent airborne obstacle threats may become red-colored and/or opaque and may show over primary flight display instrumentation. For example, imminent airborne threats 400 and 401 are displayed over airspeed indicator 404, while airborne obstacle symbols 402 and 403 remain translucent and display under the flight instrument symbols. Imminent ground obstacle threats may include similar distinguishing features.

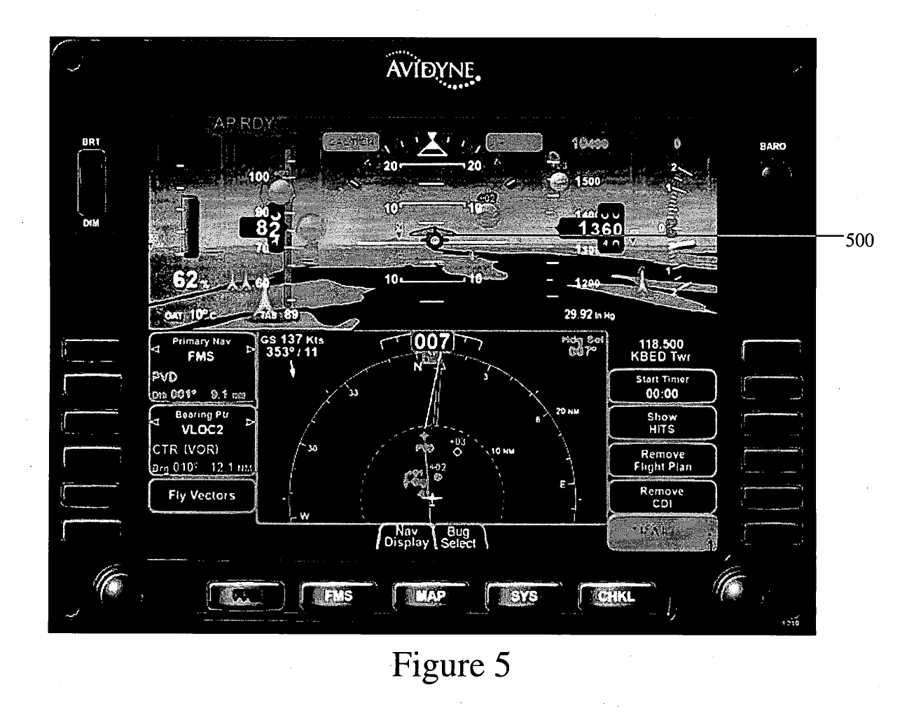

FIG. 5 shows an exemplary display of display device 106 illustrating the aircraft's safe relative distance from obstacles. Total velocity vector symbol 500 is maintained outside of all displayed avoidance zone symbols in order to keep the aircraft a safe distance from all displayed airborne and ground obstacles.

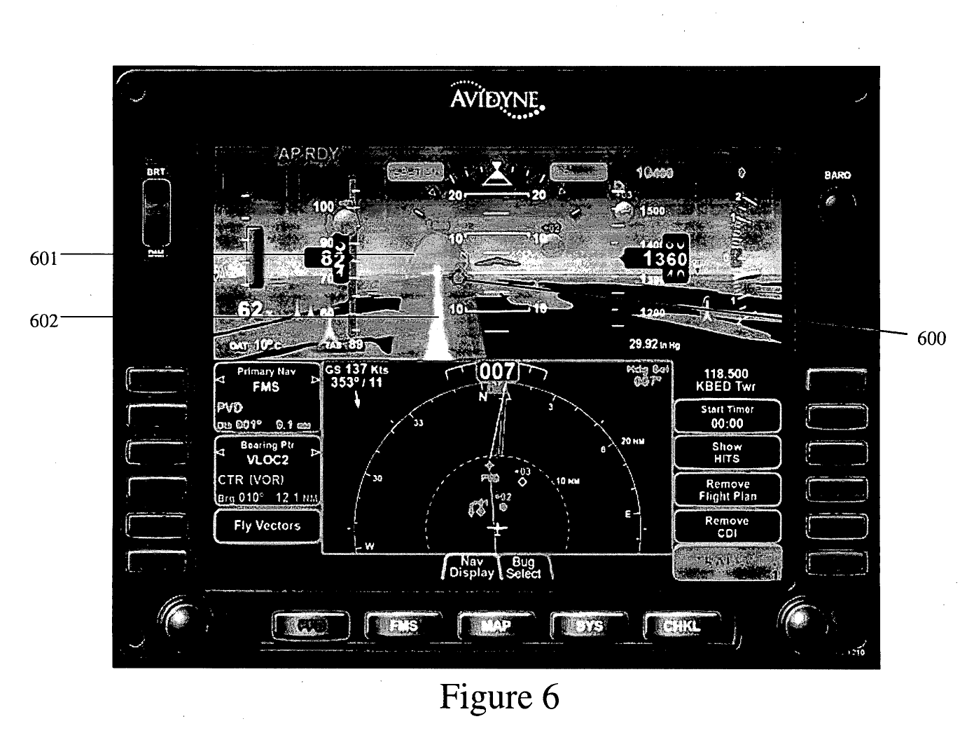

FIG. 6 shows an exemplary flight display illustrating the aircraft's unsafe relative distance from a ground obstacle. A total velocity vector is a known representation of the current flight path of the aircraft. Total velocity vector symbol 600 is displayed inside the avoidance zone symbol 601 of ground obstacle symbol 602, indicating that the aircraft may be approaching the ground obstacle at an unsafe distance. Total velocity vector symbol 600 may be accentuated with a colored border and/or glow to further draw attention to the danger.

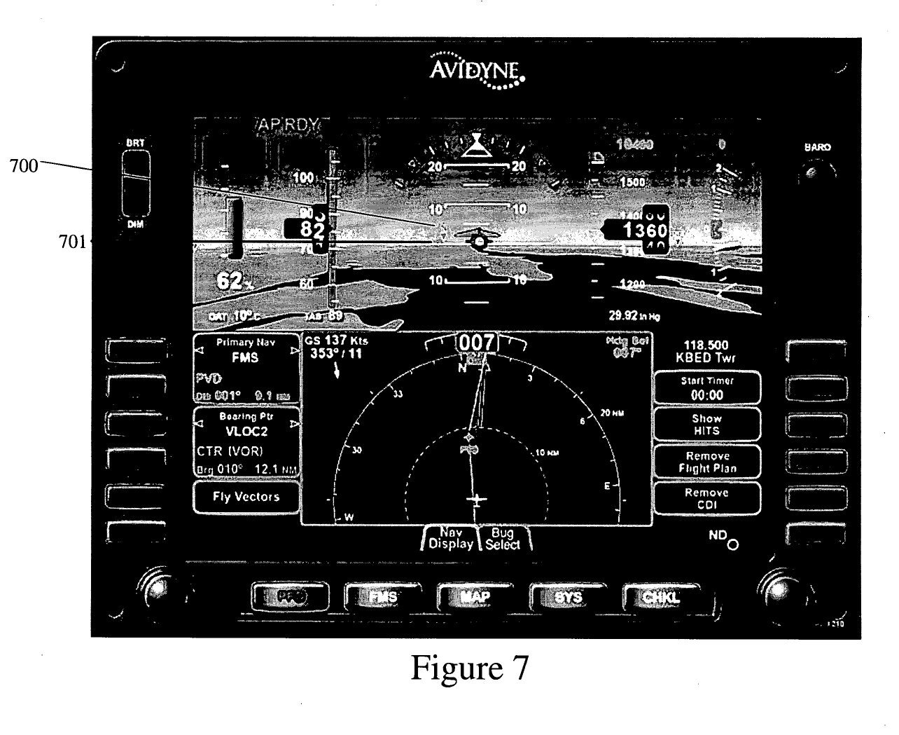

As noted above, conventional flight displays depict compass points against a flat horizon. In the preferred embodiment, however, compass points are laid along the visual horizon at the point where the sky meets the ground, no matter what the terrain height about level horizon. For example, in FIG. 7, cardinal compass point 700 is depicted at the highest point of the terrain along visual horizon 701. By displaying cardinal compass point 700 above the high terrain, the higher terrain in that direction is emphasized. Further, the display is not cluttered by having compass point 700 laying atop the high terrain.

Although preferred embodiments have been shown and described, it would be appreciated by those skilled in the art that changes may be made in these embodiments without departing from the principles and spirit of the invention, the scope of which is defined in the claims and their equivalents.

What is claimed is:

1. A flight display system which presents a pilot with a three dimensional view of an area within a potential flight path of an aircraft, the system comprising:
means for receiving position data of the aircraft in three dimensions;
means for receiving attitude data of the aircraft in three dimensions;
means for receiving terrain data;
means for displaying a three dimensional view of an area within a potential flight path of the aircraft based on the attitude data, the position data, and terrain data corresponding to terrain in a potential flight path of the aircraft, said three dimensional view including symbolic representations of potential obstacles in the potential flight path and a symbolic representation of an avoidance zone encompassing at least one of the potential obstacles.

2. The system of claim 1, wherein the avoidance zone is a geometric shape representing sufficient separation of the aircraft from the obstacle to maintain safety.

3. The system of claim 2, wherein the avoidance zone is color coded based on threat level.

4. The system of claim 2, wherein the avoidance zone is translucent.

5. The system of claim 2, wherein the avoidance zone flashes and has a colored border.

6. The system of claim 2, wherein the flight display system further comprises a total velocity vector.

7. The system of claim 6, wherein the sufficient separation of the aircraft from the obstacle is maintained by keeping the total velocity vector outside of the avoidance zone.

8. The system of claim 1, wherein the flight display system further comprises means for providing aural warnings.

9. A flight display system which presents a pilot with a three dimensional view of an area within a potential flight path of an aircraft, the system comprising:
means for receiving position data of the aircraft in three dimensions;
means for receiving attitude data of the aircraft in three dimensions;
means for receiving terrain data;
means for displaying a three dimensional view of an area within a potential flight path of the aircraft based on the attitude data, the position data, and terrain data corresponding to terrain in a potential flight path of the aircraft, said three dimensional view including a visual horizon, a cardinal compass representation aligned with the visual horizon, symbolic representations of potential obstacles in the potential flight path and a symbolic representation of an avoidance zone encompassing at least one of the potential obstacles.

10. The system of claim 9, wherein the avoidance zone is a geometric shape representing sufficient separation of the aircraft from the obstacle to maintain safety.

11. The system of claim 10, wherein the avoidance zone is color coded based on threat level.

12. The system of claim 10, wherein the avoidance zone is translucent.

13. The system of claim 10, wherein the avoidance zone flashes and has a colored border.

14. The system of claim 10, wherein the flight display system further comprises a total velocity vector.

15. The system of claim 14, wherein the sufficient separation of the aircraft from the obstacle is maintained by keeping the total velocity vector outside of the avoidance zone.

16. The system of claim 9, wherein the flight display system further comprises means for providing aural warnings.

17. A flight display system which presents a pilot with a three dimensional view of an area within a potential flight path of an aircraft, the system comprising:
means for receiving position data of the aircraft in three dimensions;
means for receiving attitude data of the aircraft in three dimensions;
means for receiving terrain data;
means for receiving aircraft traffic data including a position and type of aircraft;
means for displaying a three dimensional view of an area within a potential flight path of the aircraft based on the attitude data, the position data, and terrain data corresponding to terrain in a potential flight path of the aircraft, said three dimensional view including plural symbols representing aircraft traffic, said symbols being variable based on the type of aircraft represented.

18. The system of claim 17, wherein the three dimensional view further includes a symbolic representation of an avoidance zone surrounding at least one of the plural symbols representing aircraft traffic.

19. The system of claim 18, wherein the avoidance zone is a geometric shape representing sufficient separation of the aircraft from the obstacle to maintain safety.

20. The system of claim 19, wherein the avoidance zone is color coded based on threat level.

21. The system of claim 19, wherein the avoidance zone is translucent.

22. The system of claim 19, wherein the avoidance zone flashes and has a colored border.

23. The system of claim 19, wherein the flight display system further comprises a total velocity vector.

24. The system of claim 23, wherein the sufficient separation of the aircraft from the symbol is maintained by keeping the total velocity vector outside of the avoidance zone.

25. The system of claim 17, wherein the flight display system further comprises means for providing aural warnings.
